(19) United States
(12) Patent Application Publication
(10) Pub. No.: US 2012/0207934 A1
(43) Pub. Date: Aug. 16, 2012

(54) Spray Coating Device

(75) Inventors: Sivakumar Pasupathi, Bellville (ZA); Vladimir Mikhailovich Linkov, Bellville (ZA)

(73) Assignee: UNIVERSITY OF WESTERN CAPE, Bellville (ZA)

(21) Appl. No.: 13/501,213

(22) PCT Filed: Aug. 23, 2010
(86) PCT No.: PCT/IB10/53782

§ 371 Date: Apr. 26, 2012

(30) Foreign Application Priority Data
Oct. 19, 2009 (ZA) 2009/07267

(51) Int. Cl. B05D 3/04; B05B 9/00; B05B 17/00; B05B 3/00

(52) U.S. Cl. 427/372.2; 118/58; 118/697

(57) ABSTRACT

The invention discloses a spray coating device for coating substrates, which includes a nozzle arrangement with at least two nozzles. The nozzle arrangement includes at least one primary nozzle adapted to spray a suspension onto at least one substrate; and at least one secondary nozzle adapted to blow a gas onto the substrate. The secondary nozzle is equipped with a heating device adapted to heat the gas to a desired temperature. The invention also extends to a method of coating a suspension onto a substrate, which includes the steps of spraying a suspension onto at least one substrate by means of at least one primary nozzle; and of blowing a gas onto the substrate(s) with at least one secondary nozzle.

### FIELD OF INVENTION

The present invention relates to a spray coating device.

More particularly, the present invention relates to spray coating device for coating substrates.

### BACKGROUND TO INVENTION

Spray coating techniques are used in various applications wherein a homogeneous coating of the substrate is a prerequisite. However, for some applications, in particular regarding the fabrication of electrodes for batteries and fuel cells, the requirements of homogeneous coating is quite stringent in order to ensure high efficiency of the electrodes, in terms of both activity and to address cost issues. Accordingly an even coating of the substrate with optimum porosity is required and this can be only achieved through a well defined coating/drying process.

In order to achieve the desired coating of the substrates, one of the techniques used in a spray coater is to heat at a controlled rate the platform where the substrate is placed to ensure controlled drying of the solvent. However, the heated platform technique brings its own complications which limits continuous coating processes. Also, maintenance of the heating device can sometimes become tricky, where the whole platform needs to be dismantled and reassembled.

It is an object of the invention to suggest a spray coating device, which will assist in overcoming these problems.

### SUMMARY OF INVENTION

According to the invention, a spray coating device for coating substrates, includes a nozzle arrangement with at least two nozzles.

The nozzle arrangement may include
(a) At least one primary nozzle adapted to spray a suspension onto at least one substrate; and
(b) At least one secondary nozzle adapted to blow a gas onto the substrate.

Also according to the invention, a method of coating a suspension onto a substrate, includes the steps
(a) of spraying a suspension onto at least one substrate by means of at least one primary nozzle; and
(b) of blowing a gas onto the substrate(s) with at least one secondary nozzle.

The suspension may be any material dispersed in a solvent.

The secondary nozzle may also be used to spray the suspension onto the substrate/s.

The gas may be either air, inert gas or a reactive gas.

The primary nozzle may be controlled by software.

The secondary nozzle may be controlled by the same software that controls the primary nozzle.

The secondary nozzle may be adapted to be moved in all three directions.

The secondary nozzle may be equipped with a heating device adapted to heat the gas to a desired temperature.

The gas may be heated and blown onto the substrate at a controlled temperature.

### BRIEF DESCRIPTION OF DRAWINGS

The invention will now be described by way of example with reference to the accompanying schematic drawings.

In the drawings there is shown in:

FIG. 1: Schematic of moving nozzle concept; and

FIG. 2: Schematic of moving platform concept.

### DETAILED DESCRIPTION OF DRAWINGS

According to the invention, a spray coating device for coating substrates, includes a nozzle arrangement having more than one nozzle, is shown.

The nozzle arrangement includes
(a) At least one primary nozzle adapted to spray a suspension onto at least one substrate; and
(b) At least one secondary nozzle adapted to blow a gas onto the substrate.

The suspension is any material dispersed in a solvent.

The secondary nozzle can also be used to spray the suspension onto the substrate/s.

The gas is either air, inert gas or a reactive gas.

The primary nozzle is controlled by software.

The secondary nozzle can also be is controlled by the same software that controls the primary nozzle.

The secondary nozzle is adapted to be moved in all three directions.

The secondary nozzle is equipped with a heating device adapted to heat the gas to a desired temperature.

The gas is heated and blown onto the substrate at a controlled temperature.

The invention includes a pair-nozzle device that leads to a uniform and homogeneous coating of materials (suspensions, solutions, dispersions etc) onto substrates. The primary nozzle is used to spray the inks, dispersions or solutions etc onto the substrate, as is the case with all spray coating devices. The secondary nozzle, which is aligned in parallel to the primary nozzle, is then used to blow inert gas onto the substrate to dry the solvent from the ink/suspension/dispersion. The gas can be heated to a desired temperature, with a help of a stripe heater located in nozzle, to dry the solvent at a required rate. This allows precise control of the coat-dry process, leading to a uniform and homogeneous coating on substrates.

Efficient drying during spray coating is extremely essential to obtain uniform and homogeneous coating of the materials (in form of suspension, dispersion, solution etc) onto substrates. The drying becomes more crucial for certain applications, for example for the fabrication of electrodes for fuel cells and batteries applications. Optimum coat-dry process will ensure that the substrate is loaded with the material with optimum porosity and uniformity. Controlled drying of the substrate during coating is extremely crucial in achieving the desired results. The secondary nozzle that is described in this invention is to blow a gas onto the substrate in subsequent coating steps to ensure controlled drying.

In principle, the primary nozzle first sprays the suspension (an ink with suitable viscosity containing a solvent that is adequately volatile) according to the preset programme. The nozzle can be programmed to cover the whole area that needs coating. The spray device can be set to automatically move in both X and Y directions to ensure uniform spraying. The amount of suspension sprayed can also be controlled by adjusting the spray head. The programme can be set in such a way that the once the first coat of the suspension is achieved, the primary head is automatically turned off and the secondary head starts blowing the gas (air, inert gas or reactant gas) as per the programme in both X and Y direction to dry the substrate at a controlled rate. The process can be repeated as many times to obtain the desired loading of the material on the substrate. The gas can also be heated to the desired temperature with the help of a stripe heater which is located in the head of the secondary nozzle.

### EXAMPLE I

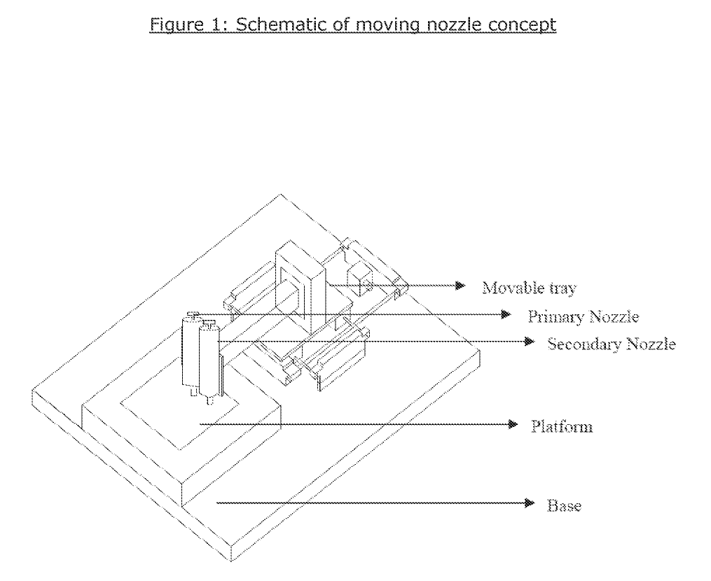

The device consists of a platform where the substrate will be placed. The platform in this case is fixed to the base of the spray coating device. Two nozzles are positioned over the platform, where the distance between the platform and the nozzle head can be adjusted accordingly. The nozzles can also be moved in X and Y directions. The movement of the nozzle can be controlled with the software. FIG. 1 provides the schematic of this concept—the moving nozzle concept.

The substrate (an electrode backing layer in this case) is placed on the platform and the suspension is filled into the primary nozzle. The secondary nozzle is connected to an inert gas. The nozzle head is then programmed in a way that it sprays the suspension along the X axis and then along Y axis. Once a first coat is sprayed, the primary head is shut and the secondary nozzle is opened where the inert gas is blown on the substrate in the same direction as the suspension was sprayed. The pressure and rate of flow of the inert gas is set prior to the experiment, which has been optimized for desired results. The secondary nozzle is also equipped with a heating device that allows heating the gas at a controlled rate of required.

### EXAMPLE II

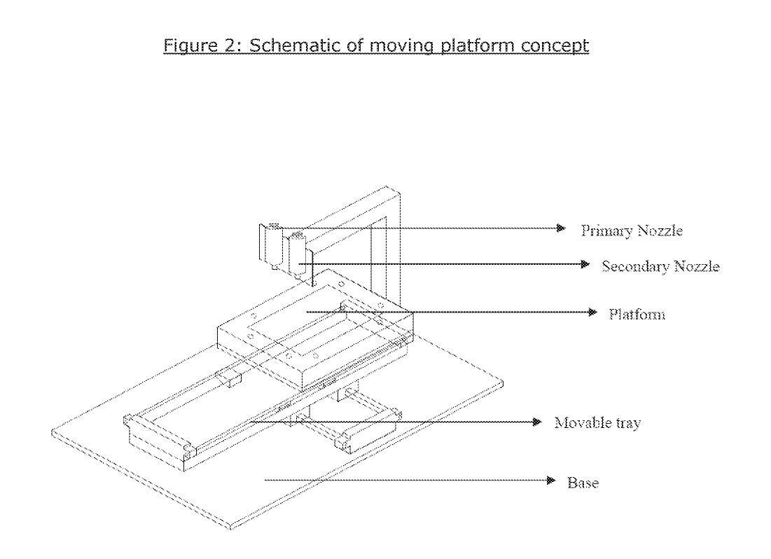

The nozzles and the platform in this case is exactly the same as with Example 1. The only difference is that in this case the nozzle is fixed permanently and the platform is moved in X and Y directions. This concept is termed as the moving platform concept and a schematic is provided in FIG. 2.

### Conclusion

The invention thus relates to a pair-nozzle spray coating device for high quality coating of substrates. The pair-nozzle device for spray coating equipment according to the invention allows maximum flexibility to optimize the spraying conditions to obtain homogeneous and uniform coating on the substrate. The primary nozzle, as in all spray coating devices, will be used for spraying the material. The secondary nozzle will be used to blow a gas (air/nitrogen/reducing or oxidising gas) to ensure smooth and homogeneous coating of the substrate with the coating material. The gas can be also heated to the desired temperature if required. The pair-nozzle device, therefore allows tailoring the spraying/drying step to obtain the desired coating of the substrates.

The challenge this invention addresses is a simple add-on device to a spray coating equipment, to ensure high quality coating onto substrates by providing maximum flexibility to tailor the spraying/drying process.

1. A spray coating device for coating substrates, which includes a nozzle arrangement with at least two nozzles.

2. A spray coating device as claimed in claim 1, in which the nozzle arrangement includes
(a) at least one primary nozzle adapted to spray a suspension onto at least one substrate; and
(b) at least one secondary nozzle adapted to blow a gas onto the substrate.

3. A spray coating device as claimed in claim 2, in which the suspension is any material dispersed in a solvent.

4. A spray coating device as claimed in claim 2 or claim 3, in which the secondary nozzle is also used to spray the suspension onto the substrate/s.

5. A spray coating device as claimed in any one of claims 2 to 4, in which the gas is either air, inert gas or a reactive gas.

6. A spray coating device as claimed in any one of claims 2 to 5, in which the primary nozzle is controlled by software.

7. A spray coating device as claimed in claim 6, in which the secondary nozzle is controlled by the same software that controls the primary nozzle.

8. A spray coating device as claimed in any one of claims 2 to 7, in which the secondary nozzle is adapted to be moved in all three directions.

9. A spray coating device as claimed in any one of claims 2 to 8, in which the secondary nozzle is equipped with a heating device adapted to heat the gas to a desired temperature.

10. A spray coating device as claimed in claim 9, in which the gas is heated and blown onto the substrate at a controlled temperature.

11. A method of coating a suspension onto a substrate, which includes the steps
(a) of spraying a suspension onto at least one substrate by means of at least one primary nozzle; and
(b) of blowing a gas onto the substrate(s) with at least one secondary nozzle.

12. A method as claimed in claim 11, in which the suspension is any material dispersed in a solvent.

13. A method as claimed in claim 11 or claim 12, in which the secondary nozzle is also used to spray the suspension onto the substrate/s.

14. A method as claimed in any one of claims 11 to 13, in which the gas is either air, inert gas or a reactive gas.

15. A method as claimed in any one of claims 11 to 14, in which the primary nozzle is controlled by software.

16. A method as claimed in claim 15, in which the secondary nozzle is controlled by the same software that controls the primary nozzle.

17. A method as claimed in any one of claims 11 to 16, in which the secondary nozzle is adapted to be moved in all three directions.

18. A method as claimed in any one of claims 11 to 17, in which the secondary nozzle is equipped with a heating device adapted to heat the gas to a desired temperature.

19. A method as claimed in claim 18, in which the gas is heated and blown onto the substrate at a controlled temperature.

20. A spray coating device substantially as hereinbefore described with reference to the accompanying drawings.

21. A method of coating a suspension onto a substrate substantially as hereinbefore described with reference to the accompanying drawings.
